(19) United States
(12) Patent Application Publication
(10) Pub. No.: US 2019/0077211 A1
(43) Pub. Date: Mar. 14, 2019

(54) VARIABLE MOTION-CONTROLLING DAMPER ASSEMBLY

(71) Applicant: Illinois Tool Works Inc., Glenview, IL (US)

(72) Inventor: Hin Bun Chow, Troy, MI (US)

(73) Assignee: Illinois Tool Works Inc., Glenview, IL (US)

(21) Appl. No.: 16/130,655

(22) Filed: Sep. 13, 2018

Related U.S. Application Data
(60) Provisional application No. 62/558,481, filed on Sep. 14, 2017.

(51) Int. Cl. B60G 17/08; F16F 9/46; F16F 9/12; F16F 9/14

(52) U.S. Cl. CPC B60G 17/08; F16F 9/462; F16F 2230/0064; F16F 9/145; F16F 9/12

(57) ABSTRACT

A damper assembly is provided that includes a housing and a rotor. The housing includes a cavity and a groove. The groove is configured for passage of damping fluid. The damper assembly defines a proximal end configured for mounting to an actuator and a distal end configured for the passage of the damping fluid, and the groove is disposed at the distal end of the cavity. The groove extends along a groove length and has at least one of a variable width or variable depth. The rotor is disposed within the housing and rotatably articulable with respect to the housing. The rotor includes a displacement member that articulates with rotation of the rotor relative to the housing along the groove length to direct the damping fluid through the groove.

### RELATED APPLICATIONS

This application claims priority to U.S. Provisional Application Ser. No. 62/558,481, filed Sep. 14, 2017, and entitled “Variable Motion-Controlling Damper Assembly,” the subject matter of which is hereby incorporated in its entirety.

### FIELD OF EMBODIMENTS OF DISCLOSURE

Embodiments of the present disclosure generally relate to a damper assembly, and, more particularly, to a damper assembly that is configured to variably control motion of a moveable member in relation to a main body.

### BACKGROUND

Various components include portions that pivot, rotate, or the like. For example, an armrest of a chair (such as within a vehicle) may include a lid (or cover) that covers a compartment within a main body. The lid is configured to pivot between an open position and a closed position. The lid may be cantilevered with respect to the main body.

As another example, a glove box or compartment within a vehicle is configured to be opened so that one or more items may be stored therein, and then closed to securely retain the item(s). A typical glove box includes a main housing and a cover (such as a door, panel, lid, or the like) that is moveably secured to the main housing between an open position and a closed position. For example, the cover may be pivotally secured to the main housing. The cover includes a securing member, such as a latch, that cooperates with a complementary structure of the main housing to ensure that the cover is secured in the closed position.

Cantilevered storage compartments, armrests, and the like have moveable members that typically pivotally couple to a component via a hinge proximate to a rear end. For example, a rear end of lid of an armrest is pivotally coupled to a main body. When opened, a center of gravity of the pivoting member (such as an armrest, cover, lid, or the like) is usually above or behind the hinge so as to remain open. To close, the pivoting member is normally actuated manually to initiate the closing movement until gravity takes over (overcomes friction in the system). The pivoting member accelerates during the closing motion due to the combination of gravity and increase of horizontal leverage. Such quick movement may generate noise when the pivoting member closes (for example, slams shut).

Dampers may be used to slow down such motion, especially at the end of the closing stroke. However, conventional viscous dampers may not adequately slow the motion immediately before full closure to avoid noise and shock, due to the rapid increase of speed and leverage.

### BRIEF SUMMARY

In an example embodiment, a damper assembly is provided that includes a housing and a rotor. The housing includes a cavity and a groove. The groove is configured for passage of damping fluid. The damper assembly defines a proximal end configured for mounting to an actuator and a distal end configured for the passage of the damping fluid, and the groove is disposed at the distal end of the cavity. The groove extends along a groove length and has at least one of a variable width or variable depth. The rotor is disposed within the housing and rotatably articulable with respect to the housing. The rotor includes a displacement member that articulates with rotation of the rotor relative to the housing along the groove length to direct the damping fluid through the groove.

In another example embodiment, a lid assembly includes a lid and a damper assembly. The lid has a hinge axis at which the lid pivots with respect to a container, and includes an actuator disposed along the hinge axis. The damper assembly is disposed along the hinge axis and operably coupled to the actuator. The damper assembly includes a housing and a rotor. The housing includes a cavity and a groove. The groove is configured for passage of damping fluid. The damper assembly defines a proximal end configured for mounting to the actuator and a distal end configured for the passage of the damping fluid, with the groove disposed at the distal end of the cavity. The groove extends along a groove length and has at least one of a variable width or variable depth. The rotor is disposed within the housing and is rotatably articulable with respect to the housing. The rotor includes a displacement member that articulates with rotation of the rotor relative to the housing along the groove length to direct the damping fluid through the groove.

### DESCRIPTION OF DRAWINGS

FIG. 1 provides a side sectional view of a damper assembly formed in accordance with various embodiments.

FIG. 2a provides a side sectional view of the damper assembly.

FIG. 2b provides an enlarged view of the proximal end of the damper assembly of FIG. 2a in a by-pass position.

FIG. 2c provides an enlarged view of the proximal end of the damper assembly of FIG. 2a in a damping position.

FIG. 3 illustrates armrest closing characteristics according to further embodiments of the disclosure.

FIG. 4 illustrates armrest opening characteristics according to further embodiments of the disclosure.

FIG. 5 provides a perspective view of a damper assembly according to further embodiments of the disclosure.

FIG. 6 provides a perspective view of the damper assembly of FIG. 5 with a cam surface engaged by an actuator.

FIG. 7 provides a perspective view of the damper assembly of FIG. 5 with a cam surface not engaged by an actuator.

FIG. 8 provides a perspective view of a distal end of the damper assembly.

FIG. 9 provides a perspective view of a rotor of the damper assembly.

FIG. 10 provides a side perspective view of a damper assembly according to further embodiments of the disclosure.

FIG. 11 provides a plan view of a housing of the damper assembly.

FIG. 12 provides a side view of a rotor of the damper assembly.

FIG. 13a illustrates a lid assembly with a lid open, according to further embodiments of the disclosure.

FIG. 13b illustrates the lid assembly of FIG. 13a with the lid closed.

FIG. 14a provides a rear view of the lid assembly of FIG. 13a.

FIG. 14b provides a perspective view of the lid assembly of FIG. 13a.

FIG. 14c shows an enlarged view of a portion of the lid assembly of FIG. 13a along the hinge axis.

FIG. 15 illustrates a graph indicating displacement in relation to rotational position of a moveable member, according to further embodiments of the disclosure.

FIG. 16 illustrates views of a damper assembly when the moveable member is in position A of FIG. 15.

FIG. 17 illustrates views of the damper assembly when the lid is in position B of FIG. 15.

FIG. 18 illustrates views of the damper assembly when the lid is in position C of FIG. 15.

FIG. 19 illustrates views of the damper assembly when the lid is in position D of FIG. 15.

FIG. 20 illustrates views of the damper assembly when the lid is in position E of FIG. 15.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION

Embodiments of the present disclosure provide a damper assembly that is configured to dampen or otherwise control motion between a moveable member (such as a lid or cover) with respect to another structure (such as a main body of an armrest). Instead of a fluid displacement orifice of fixed size and at a fixed location as with conventional displacement dampers, the damper assembly of various embodiments of the present disclosure includes a groove having a width and/or depth that may vary through a range of motion of a rotor in relation to a housing. The groove is configured to allow damping fluid to be squeezed therethrough. Additionally, the rotor may be configured to move away from the displacement groove during an opening motion via cam action with a portion of the moveable member, thereby easing opening effort.

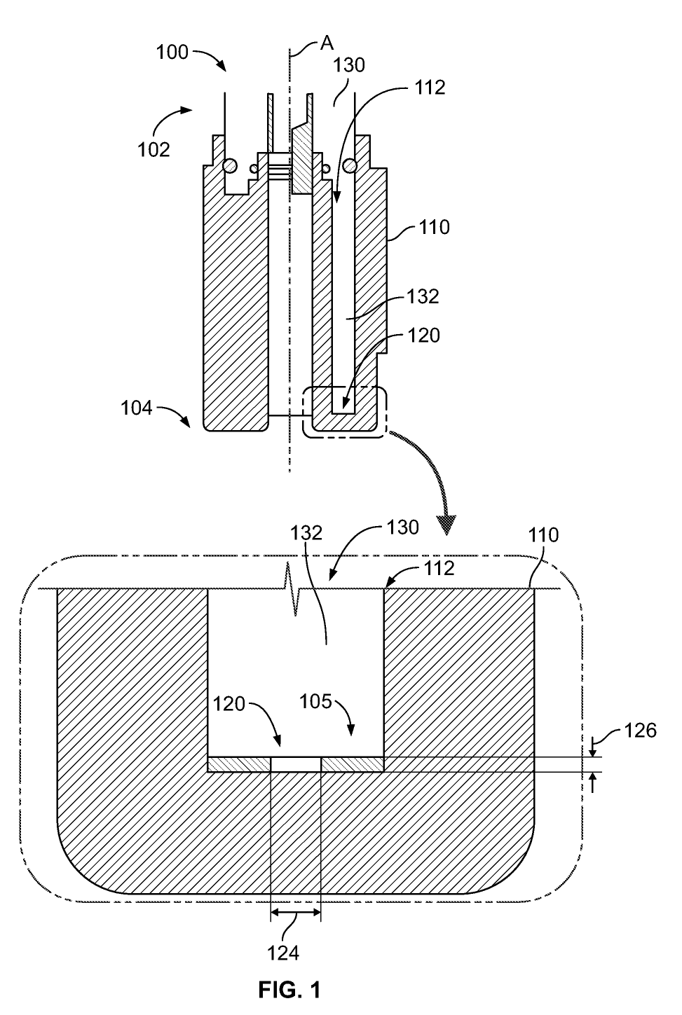

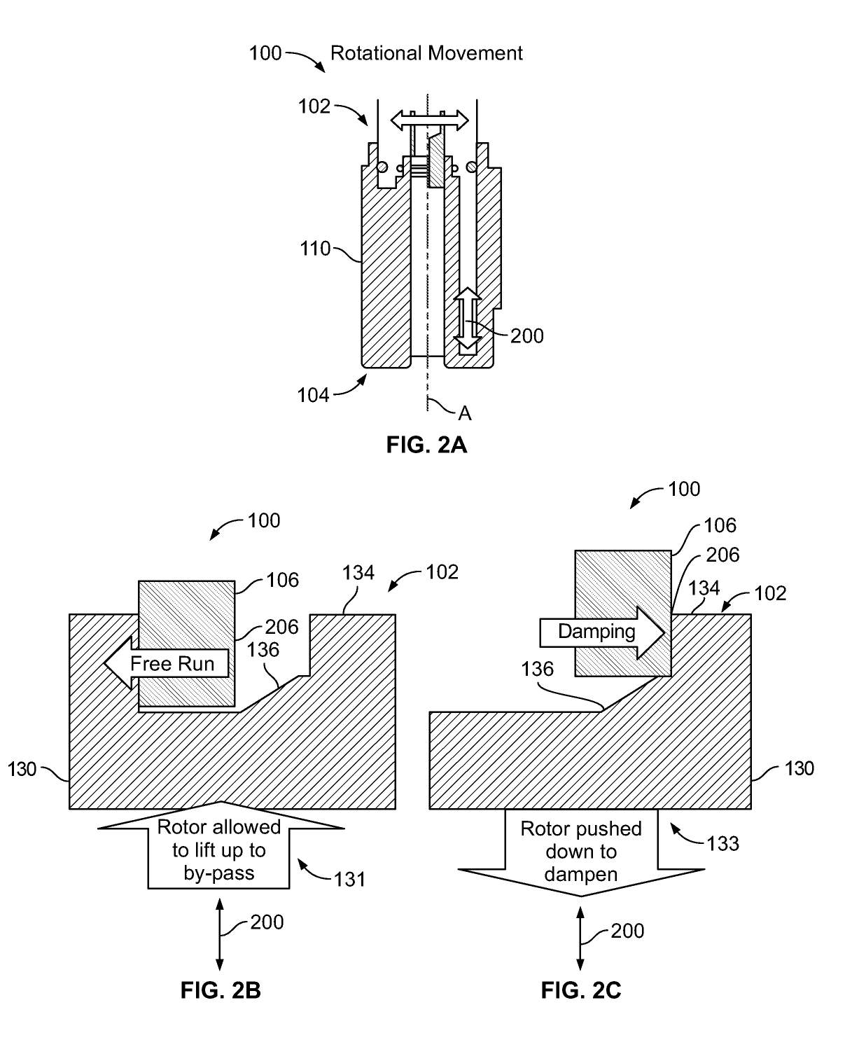

FIG. 1 provides a side sectional view of a damper assembly 100 formed in accordance with various embodiments. The depicted example damper assembly 100 includes a housing 110 and a rotor 130. Generally, the rotor 130 is actuated to rotate about axis A within the housing 110, with damping provided by movement of a damping fluid disposed within the housing 110 with the rotor 130. Interactions between the rotor 130 and the damping fluid provide a damping effect (e.g., on an external structure operably coupled to the rotor 130 and whose movement is used to actuate the rotor 130). As seen in FIG. 1, the damper assembly 100 includes a proximal end 102 (configured for mounting to an actuator; for an example of an actuator 106; see FIGS. 2a-c) and a distal end 104 that is opposite the proximal end 102. The distal end 104 in the illustrated embodiment is configured for passage of the damping fluid. The proximal end 102 may be understood as the end closest or most proximal to the actuator 106, and the distal end 104 may be understood as the end farthest or most distant from the actuator 106.

As seen in FIG. 1, the housing 110 includes a cavity 112 and a groove 120. The groove 120 is configured for passage of damping fluid. In the illustrated example, the groove 120 is disposed at a distal end 105 of the cavity 112. The groove extends along a groove length 122 that extends into and out of the page as seen in the enlarged sectional view of FIG. 1. (See, e.g., FIG. 11 for a depiction of a groove length.) The groove 112 has a width 124 and a depth 126. At least one of the width 124 and/or depth 126 is variable along the length 122. For example, with the view of FIG. 1 taken at a given point along the length 122, the width 124 may be greater or less than the width 124 shown in FIG. 1 at other points along the length 122. Additionally or alternatively, the depth 126 may be greater or less than the depth 126 shown in FIG. 1 at other points along the length 122. Accordingly, as the rotor 130 rotates in the housing 110 and interacts with the damping fluid, the cross-sectional area available to the damping fluid in the groove 120 changes with the change in width and/or depth, resulting in a corresponding change in the amount of damping.

The rotor 130 of the illustrated example is disposed within the housing 110, and is rotatably articulable about the axis A with respect to the housing 110. The rotor 130 includes a displacement member 132 that articulates with rotation of the rotor 130 relative to the housing 110 along the groove length 122 to direct damping fluid through the groove 120. In various embodiments, the interaction between the displacement member 132 or a portion thereof (e.g., a distal portion of the displacement member) and the damping fluid determines the amount of damping provided.

By varying a width and/or depth of a fluid displacement groove, as discussed herein, in the damper assembly through a range of motion, an amount of fluid flowing through the displacement groove may be varied based on the position of the rotor indexed to a moveable member that actuates the rotor. By tailoring the width and/or depth of the groove according to a position of the rotor, for example, damping resistance may be increased sharply to decelerate the moveable member shortly before full closure. Further, the width and/or depth of the groove may be eliminated, minimized, or otherwise reduced at an end of travel to create a “detent” feel when the moveable member is fully closed, for example.

It may be noted that, in various embodiments, a free-run function is selectably engaged (e.g., via a cam surface on the top (or proximal end 102) of the rotor 130). During closure, a mating protuberance (for example, a rib 206) from an associated moveable member (such as a lid, for example) rides up onto a ramp (e.g., sloped cam surface 136) on the top of the rotor (which forces the rotor down into the housing) to ensure damping fluid is squeezed through the displacement groove 120. During opening, the mating protuberance shifts away from the ramp to allow the rotor to slip and/or lift away from the displacement groove 120 due to increased pressure inside the viscous fluid. Accordingly, with the rotor 130 in a by-pass position, the damping fluid flows freely and provides relatively little damping. However, with the rotor 130 in a damping position, the damping fluid is urged through the groove 120 and more damping is provided.

FIGS. 2a-c provide various views of an example embodiment of the damper assembly 100 that allows for a free-run function. FIG. 2a provides a side sectional view of the damper assembly 100, FIG. 2b provides an enlarged view of the proximal end 102 of the damper assembly 100 in a by-pass position, and FIG. 2C provides an enlarged view of the proximal end 102 of the damper assembly in a damping position. As best seen in FIG. 2a, rotational movement of the rotor 130 about the axis A results in an axial movement of the rotor 130 along direction 200 in addition to rotation of the rotor 130.

As seen in FIGS. 2b and 2c, the rotor 130 includes an actuator rib 134 that is disposed at or near the proximal end 102 of the damper assembly 100 (e.g., on a top or upper surface of the rotor 130). The actuator rib 134 is configured to be contacted by the actuator 106 to urge the rotor 130 to rotate in the housing 110. In the illustrated embodiment, the actuator 106 includes an actuating rib 206 that is urged against the actuator rib 134 to rotate the actuator rib 134 about the axis A. It may be noted that plural actuator ribs 134 may be utilized. For example, the actuating rib 206 may urge one actuator rib 134 in a first direction to open or urge the damper assembly 100 into a by-pass position, and urge a different actuator rib 134 in a second, opposite direction to close or urge the damper assembly 100 to a damping position.

The rotor 130 of the embodiment depicted in FIGS. 2a-2c is axially movable within the housing 110 (along direction 200). The rotor 130 defines a by-pass position at a first axial position 131 (see FIG. 2b) and a damping position at a second axial position 133 (see FIG. 2c). The rotor 130 may be urged toward the distal end 104 of the damper assembly 100 to move from the first axial position 131 to the second axial position 133 (or urged toward the proximal end 102 or away from the distal end 104 to move from the second position 133 to the first position 131). In the first axial position 131, the rotor 130 is displaced away from the distal end 104 and away from the groove 120, along the damping fluid to flow freely. In the second axial position 133, the rotor 130 is urged toward the distal end 104 and the groove 120, such that the rotor 130 constrains the fluid within the groove 120 or urges the fluid through the groove 120 to provide damping.

In the illustrated embodiment, as best seen in FIG. 2b and FIG. 2c, the rotor 130 has a sloped cam surface 136 that is disposed at or near the proximal end 102 of the damper assembly 100 (e.g., on a top or upper surface of the rotor 130). The rotor 130 is displaced axially as the actuator 106 rotates along the sloped cam surface 136. For example, as seen in FIG. 2b, when the actuator 106 has rotated away from the sloped cam surface 136, the rotor 130 is allowed to lift up axially (e.g., away from the distal end 104) placing the damper assembly 100 in a free-run or by-pass condition. As seen in FIG. 2c, when the actuator 106 rotates against the sloped cam surface 136, the rotor 130 is urged axially downward (e.g., toward the distal end 104), thereby placing the damper assembly 100 in a damping condition. Accordingly, the damping may be activated when most desired or appropriate, and de-activated at other times during motion of an external structure that is being damped by the damper assembly 100.

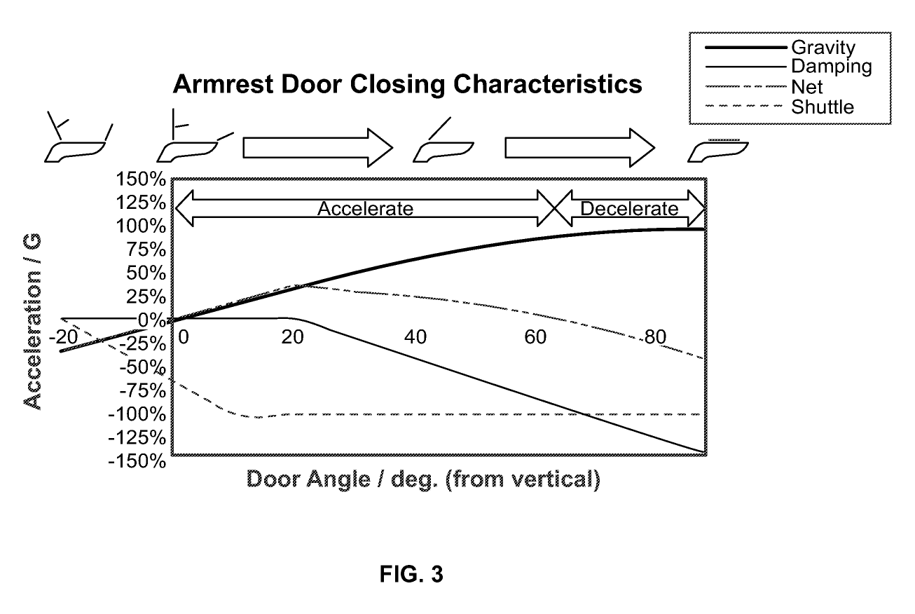

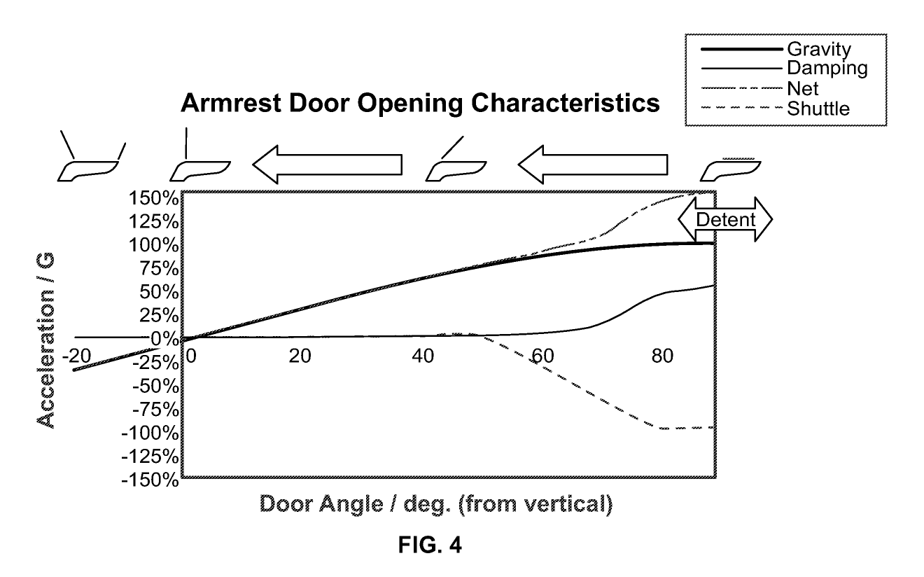

In various embodiments, for example, the damper assembly 100 may be used in connection with a lid or other hinged structure. In some embodiments, the damper assembly 100 may be used in connection with a lid on an armrest (e.g., an armrest in a passenger compartment of a vehicle). FIGS. 3 and 4 illustrate armrest closing and opening characteristics, respectively, according to an embodiment of the present disclosure. The particular dimensions of the damper assembly 100 (e.g., variable width 122 and/or variable depth 124 of the groove 120) may be configured to address the different accelerations and decelerations experienced by a particular armrest design, to provide improved damping performance tailored for the particular application.

It may be noted that in various embodiments, the variable width and/or depth of the groove 120 allows for a damper assembly having a uniform wall thickness, thereby providing effective dimensional and geometric accuracy of injection molded parts, especially for high precision products. The cam feature (e.g. sloped cam surface 136) in various embodiments cooperates with a mating protuberance from an existing structure (such as a lid of an armrest), thereby reducing a number of components for the damper assembly. As such, a simpler, more efficient damper assembly is provided.

It may be noted that the damper assembly according to embodiments of the present disclosure varies damping force depending on the position of an associated moveable member (such as a lid of an armrest), reduces resistance in an opening direction, reduces a number of components, reduces weight, reduces cost, increases efficiency and precision of operation, simplifies a manufacturing process, and/or may be configured to provide a detent feature.

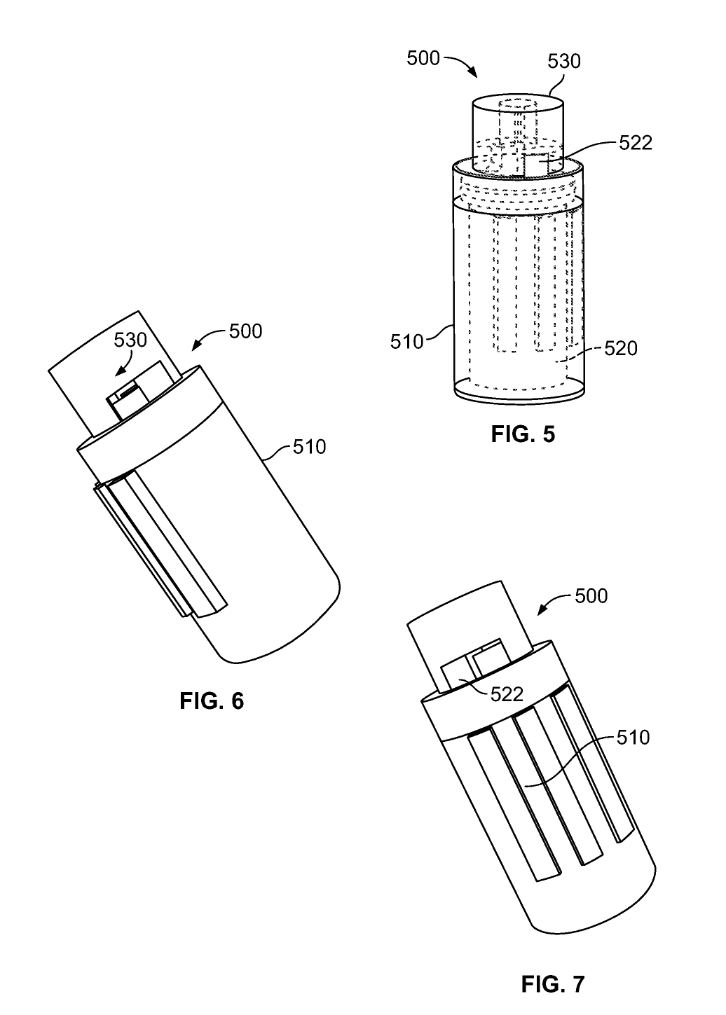

FIGS. 5-7 provide perspective views of a damper assembly 500, according to an embodiment of the present disclosure. The damper assembly 500 may be generally similar in one or more aspects as the damper assembly 100 discussed herein. The depicted damper assembly 500 includes a housing 510, a rotor 520, and an adaptor 530. The housing 510 may be generally similar to the housing 110 in various respects, the rotor 520 may be generally similar to the rotor 130 in various respects, and the adaptor 530 may be generally similar to the actuator 106 in various respects. For example, the rotor 520 includes a cam surface 522 that may be generally similar to the sloped cam surface 136. Generally, the adaptor 530 (which may be mounted to an associated movable structure, such as an armrest lid) is used to actuate the rotor 520 to rotate in the housing 510, providing for damping (e.g., based on an interaction between the moving rotor 520 and damping fluid. The amount of damping, as discussed herein, may be variable depending on the position (and/or the direction of rotation) of the rotor 520. The size (for example, width) of the displacement groove (e.g., groove 120) in the bottom of the housing may be changed (for example, reduced) to increase resistance when a lid of an armrest is closing. In effect, the displacement groove acts to provide a smooth brake to reduce the chance that the lid slams shut, and to reduce undesirable noise when the lid fully closes in relation to the main body of the armrest. The cross-sectional area of the displacement groove may be increased to reduce damping resistance and decreased to provide increased damping resistance.

As shown in FIG. 5, when the cam surface 522 of the rotor 520 is mated to a component (such as the adapter 530 of a lid of an armrest), closing motion of the moveable member (such as the lid) may urge the rotor 520 into the housing 510 to displace the damping fluid via the displacement groove. During opening, the lid allows the rotor 520 to back away from the displacement groove due to build-up of fluid pressure (e.g., via movement of the adaptor 530 to a position at which the cam surface 522 is not engaged and the rotor 520 is freed to move axially away from the distal end). In FIG. 6, the cam surface 522 is engaged by a rib 532 of the actuator 530 (e.g., with a corresponding lid closed), while in FIG. 7, the cam surface 522 is not engaged by the rib 532 (e.g., with a corresponding lid open).

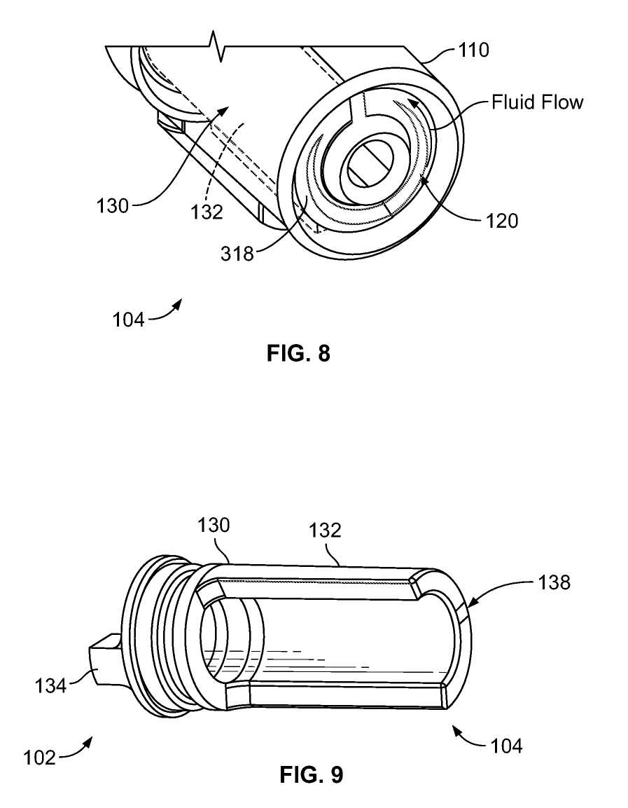

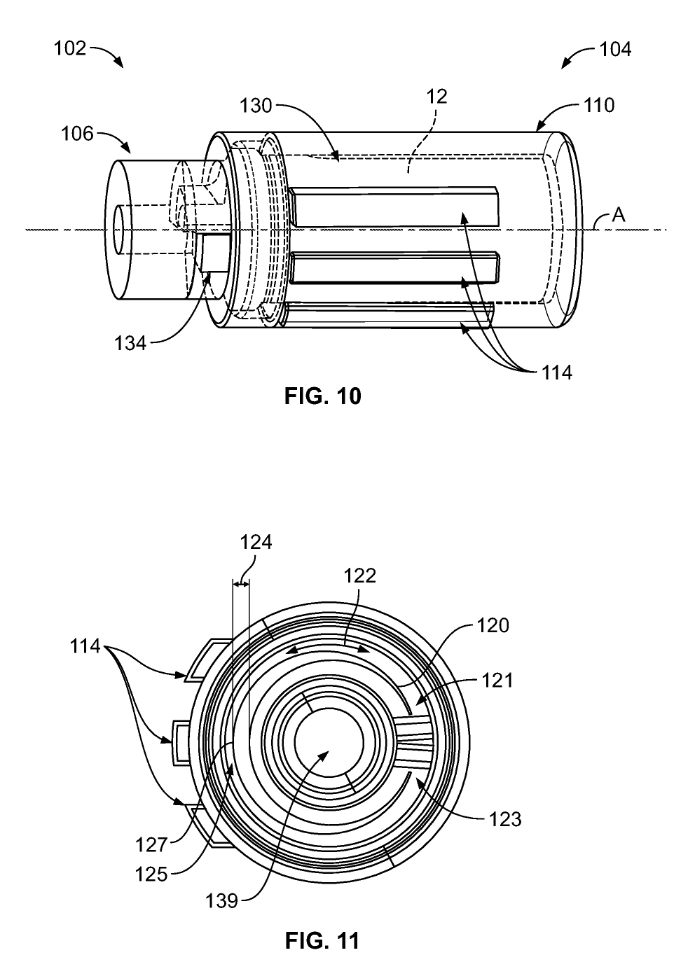

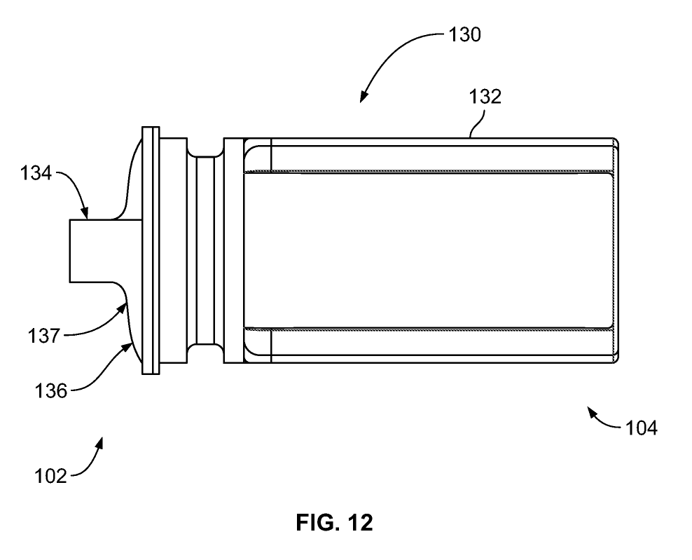

FIGS. 8-12 depict various aspects of example components of the damper assembly 100 (e.g., a damper assembly of FIGS. 1 and 2). FIG. 8 provides a perspective view of the distal end 104 of the damper assembly 100 (with the housing 110 transparent to help shown internal features and the rotor 130). FIG. 9 provides a perspective view of the rotor 130. FIG. 10 provides a side perspective view of the damper assembly 100 (with the housing 110 transparent to help shown internal features and the rotor 130). FIG. 11 shows a plan view of the housing 110. FIG. 12 shows a side view of the rotor 130. Any of the features of FIGS. 8-12 may be incorporated into any of the embodiments disclosed herein.

As discussed herein, the damper assembly in various embodiments is configured to be coupled to a fixed structure, such as a main body of an armrest. A moveable member of the fixed structure (such as a lid) includes at least one protuberance (such as actuating rib 206 of FIGS. 2b and 2c, or a pair of such ribs) that cooperate with the rotor 130 during opening and closing. During operation, the rotor 130 axially moves in the housing 110 and also rotates within the housing 110 based on the motion of the moveable member. The rotor 130 rotates and slides axially independently in various embodiments, so the rotor 130 is able to rotate and slide at the same time in relation to the housing 110.

As discussed herein, the amount of damping provided by the damper assembly 100 is based on a location of the moveable member (e.g., lid), which in turn determines the position of the rotor 130 and thereby changes the amount of damping based on the relative position of the rotor 130 with respect to the groove 120. In various embodiments, as the moveable member closes, damping force increases due to the constriction of the displacement groove (resulting in a smaller flow path), such as a narrowing of the width of the C-shaped groove 120 shown in FIG. 8. As the moveable member opens, the displacement groove 120 widens or opens, and also the rotor 130 moves up in relation to the groove 120 (or moves toward the proximal end 102 or away from the groove 120), thereby increasing the width of the displacement groove and depth of the fluid path. As such, an increased amount of fluid passes through the expanded displacement groove, which assists in opening the moveable member. That is, the width of the displacement groove 120, as well as the flow path over the displacement groove 120 expands as the rotor 130 rotates within the housing 110 and moves upwardly in relation to the housing 110, thereby increasing fluid flow within the damper assembly 100.

As best seen in FIGS. 8 and 11, the groove 120 defines a C-shape along the groove length 122. Further, as best seen in FIGS. 8 and 9, the displacement member 132 of the rotor 130 defines a complimentary C-shape (e.g., a C-shape having a similar radial size or radius and overlapping at least partially with the C-shape defined by the groove 120). As best seen in FIG. 11, the groove 120 extends from a first end 121 to a second end 123. The variable width 124 reaches a maximum value at an intermediate point 125 between the first end 121 and the second end 123. For example, for the embodiment depicted in FIG. 11, the variable width 124 reaches a maximum width M at a midpoint 127 disposed evenly between the first end 121 and the second end 123 (i.e., at an equal distance from the first end 121 and second 123). Further still, in the illustrated embodiment, the variable width 124 is symmetric about the midpoint 127 along the length 122. Accordingly, the width 124 at the first end 121 is the same as the width 124 at the second end 123. Such a symmetric arrangement as depicted in FIG. 11 with a relatively narrow width at the ends provides maximum damping resistance at ends of motion, while the relative wider width at the midpoint 127 provides reduced damping resistance toward a middle portion of the travel of the rotor 130 (and accordingly, toward the middle portion of travel of a moveable member (e.g., lid) associated with the rotor 130.

As best seen in FIG. 11, the housing 110 includes an opening 139 that passes along the length of the housing 110. The opening 139 in various embodiments is configured to accept a rod or pin (e.g., hinge axle), allowing the housing 110 to be mounted along an axis (e.g., hinge axis 1012 as discussed in connection with FIGS. 10 and 11 below).

As best seen in FIG. 12, the rotor 130 includes a locking plateau 137. The locking plateau 137 in the illustrated embodiment is located on a proximal or upper surface of the rotor 130, or a surface oriented toward the proximal end 102. The locking plateau 137 defines a flat surface (e.g., a surface oriented normal to the axis passing along the center of rotation of the rotor) radially inward of and adjacent to the sloped cam surface 136. The locking plateau 137 is configured to help lock or secure the rotor 130 at maximum engagement. For example, a rib of an actuator after passing upward (or proximally) along the sloped cam surface 136 may encounter and contact the locking plateau 137 to secure or lock the rotor 130 at maximum engagement (e.g., a position at which the rotor 130 is positioned most distally).

As discussed herein, the rotor 130 is configured to rotate in relation to the housing 110 during operation. Rotation of the rotor varies the size of the corresponding portion of the displacement groove 124, thereby varying a rate of damping fluid therethrough, which varies an amount of damping force. Additionally (or alternatively), the rotor 130 may be configured to axially move in relation to the housing during operation, which changes fluid flow through a fluid path (such as by increasing a depth of a fluid passage). As such, the damper assembly 100 is configured to vary a rate of fluid flow by the rotor 130 by rotating and/or axially moving in relation to the housing. In at least one embodiment, the rotor 130 may include a displacement groove (instead of the housing) that varies when the rotor moves relative to the housing. As best seen in FIGS. 10 and 11, the housing 110 includes external ribs 114 configured to prevent the housing 110 from rotating with the actuator 106 and rotor 130. For example, the external ribs 114 may be fits in slots or openings of an external structure to prevent rotation of the housing 110.

As best seen in FIGS. 8 and 9, the rotor 130 may include a protuberance, such as a tuning rib, that is retained within a track of the housing. For example, in the illustrated embodiment, the rotor 130 includes a tuning rib 138 disposed at the distal end 104 of the displacement member 132 (e.g., along the bottom or distal portion of the C-shaped member). The tuning rib 138 is configured to cooperate with the groove 120 to urge damping fluid through the groove 120. Referring to FIGS. 8 and 9, the tuning rib 138 may move within a track (e.g., the groove 120 or a portion thereof, or a track disposed proximate to the groove 120) formed in the bottom of the housing. Damping fluid passes from a fore chamber to an aft chamber beneath the tuning rib 138, at an end of the displacement groove 120. The tuning rib 138 acts akin to a wiper blade and provides an orthogonal choke point to squeeze damping fluid through the track and into the displacement groove 120, for example.

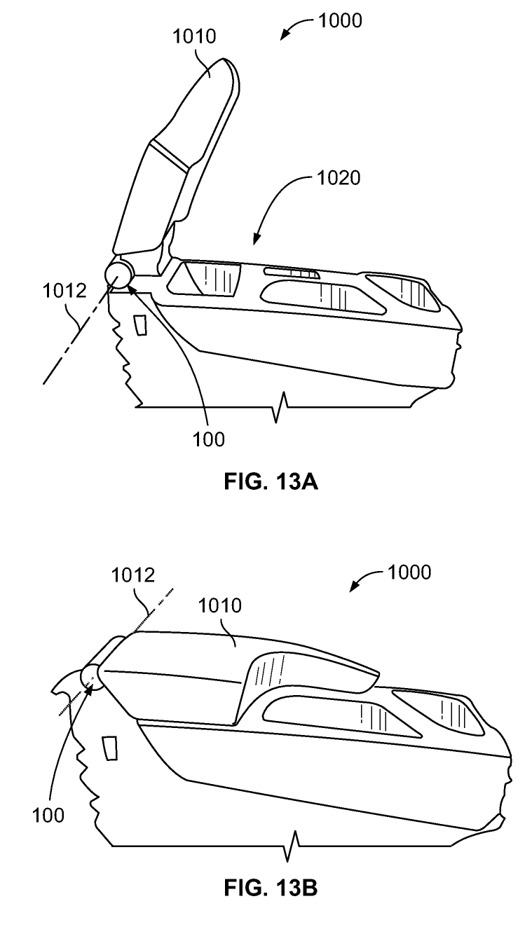

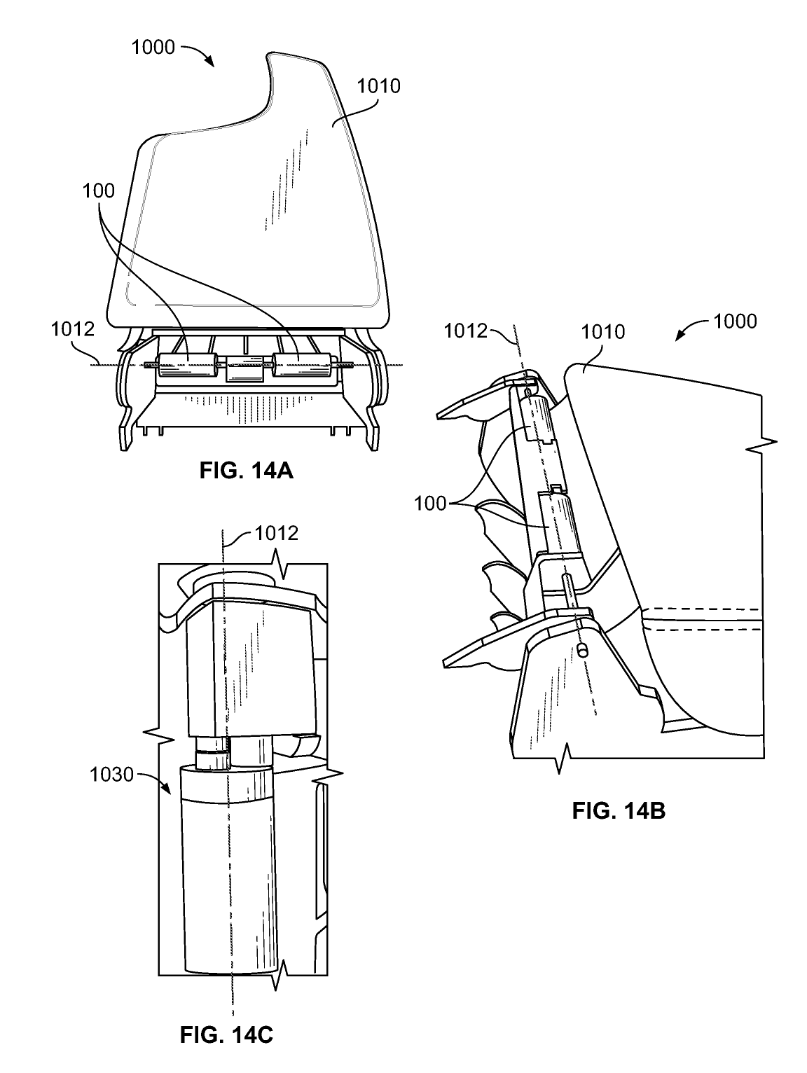

As discussed herein, in various embodiments, a damper assembly (e.g., damper assembly 100) is used in connection with a lid or other hinged member. FIGS. 13a, 13b, 14a, 14b, and 14c depict an example lid assembly 1000 that includes a damper assembly according to various embodiments. The lid assembly 1000 of the illustrated embodiment is configured to work in connection with an armrest for a vehicle interior. The lid assembly 1000 includes a lid 1010 and a damper assembly 100. The damper assembly 100 may be generally similar to the damper assembly discussed above and may include any of the features disclosed herein. The lid 1010 is configured to act as an armrest as well as for covering a container 1020. The lid 1010 is configured to pivot a hinge axis 1012 with respect to the container 1020, to open and close the container 1020. The lid 1010 includes an actuator 1030 (see FIG. 14c) that is disposed along the hinge axis 1012. While the lid 1010 rotates, the actuator 1030 rotates with the lid 1010 to rotate a rotor 130 of the damper assembly 100, with the damper assembly 100 providing damping to the lid 1010 during opening and/or closing of the lid (e.g., as discussed in connection with FIGS. 1-12).

FIG. 13a illustrates the lid assembly 1000 with the lid 1010 open, and FIG. 13b illustrates the lid assembly 1000 with the lid 1010 closed. FIG. 14a provides a rear view of the lid assembly 1000, FIG. 14b provides a perspective view of the lid assembly 1000, and FIG. 14c shows an enlarged view of a portion of the lid assembly 1000 along the hinge axis 1012. For the illustrated embodiment, two damper assemblies 100 are utilized along the hinge axis 1012.

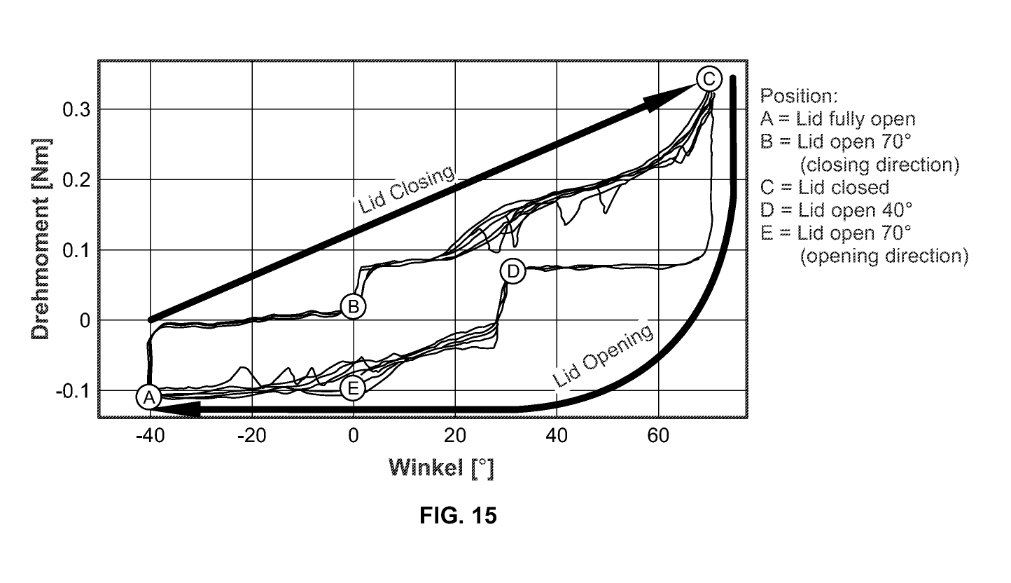

FIG. 15 illustrates a graph indicating displacement in relation to rotational position of a moveable member (for example, an adaptor coupled to a lid of an armrest), according to an embodiment of the present disclosure. Five positions—A through E—of various rotational positions are displayed on the graph. It may be noted that the displacements relative to rotational position may be dependent on direction of rotation (opening or closing), as the damper assembly may be in by-pass or free-run position or mode in one direction, and a damping or engaged position or mode in the other direction.

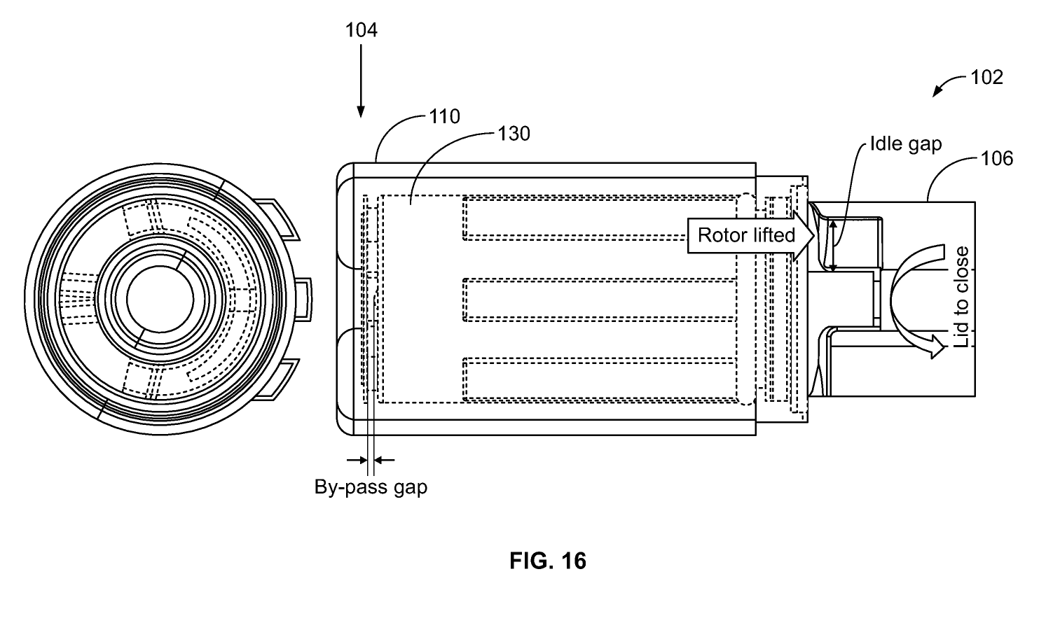

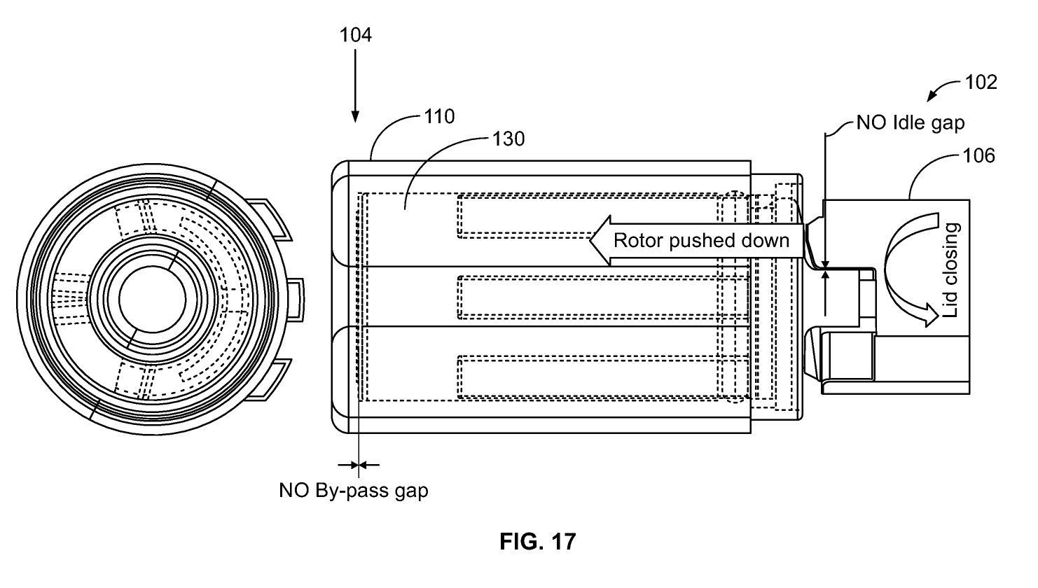

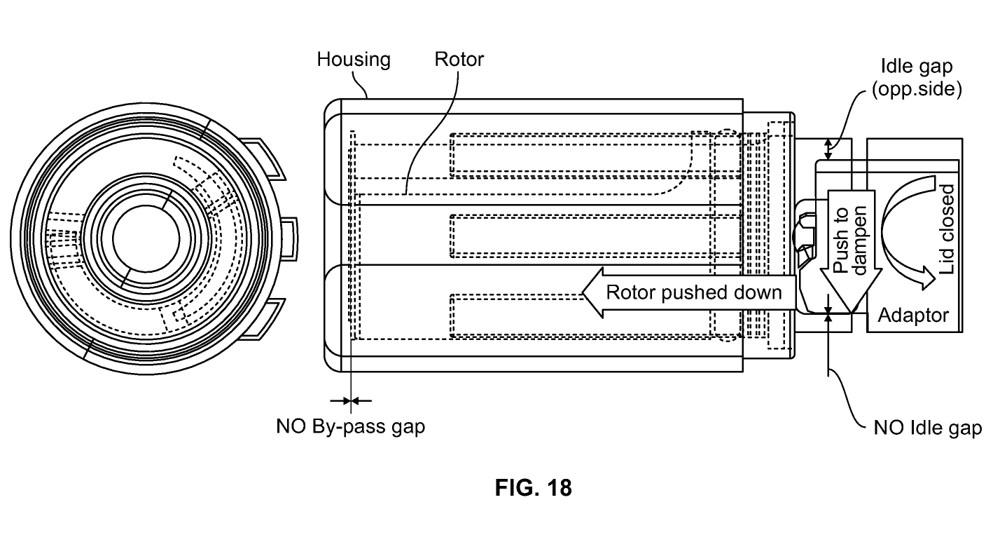

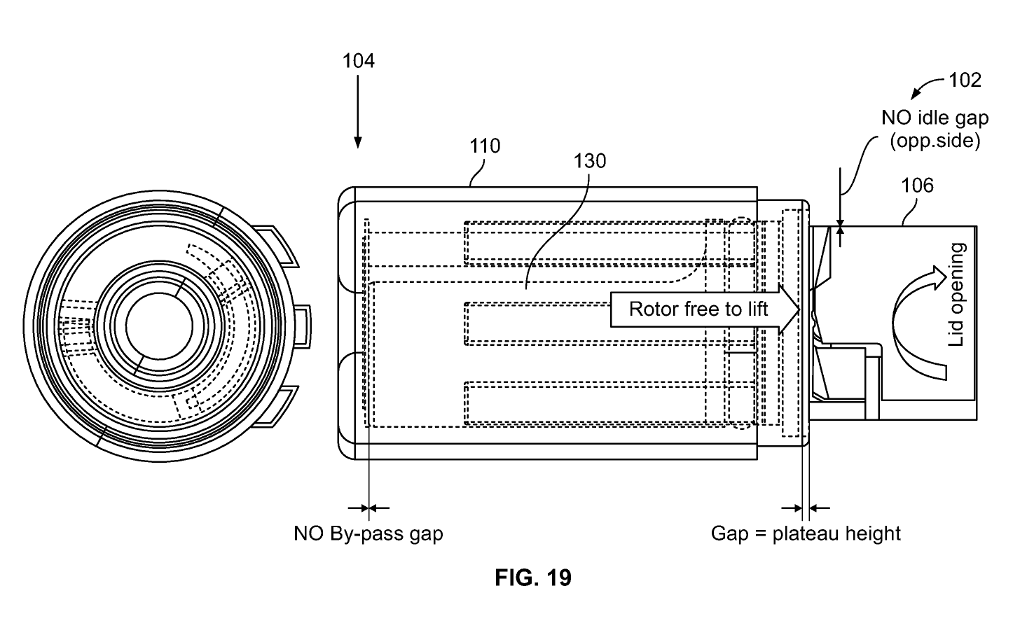

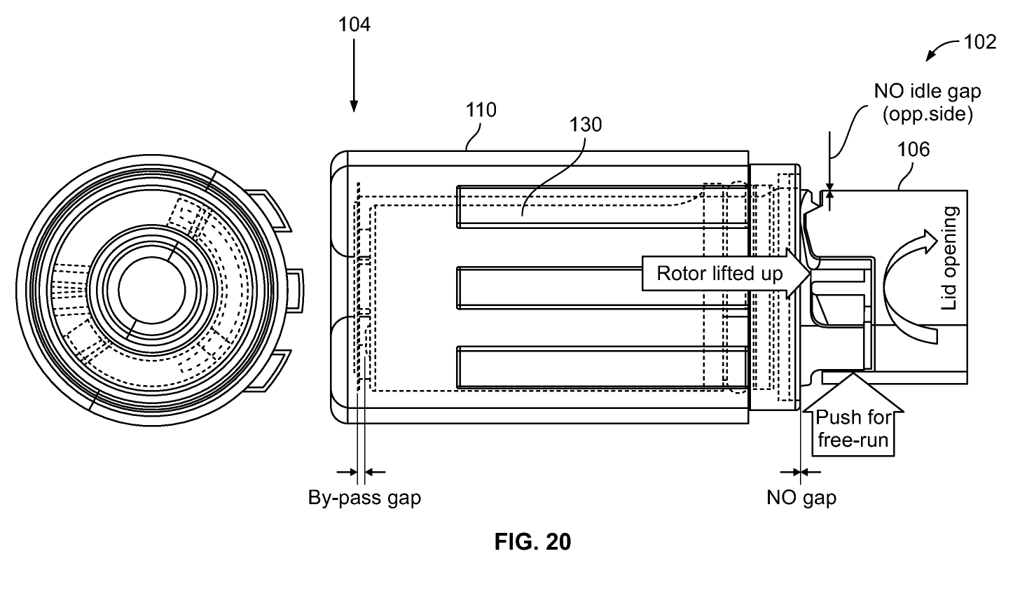

FIG. 16 illustrates views of the damper assembly 100 when the moveable member is fully open (position A of FIG. 15), according to an embodiment of the present disclosure. FIG. 17 illustrates views of the damper assembly 100 when the lid is closing (position B of FIG. 15). FIG. 18 illustrates views of the damper assembly 100 when the lid is closed (position C of FIG. 15). FIG. 19 illustrates views of the damper assembly when the lid is 40 degrees open and moving in the opening direction (position D of FIG. 15). FIG. 20 illustrates views of the damper assembly 100 when the lid is open 70 degrees and moving in the opening direction (position E of FIG. 15). Because of free-run in opening direction, the closing and opening torque paths do not overlap. As seen in FIGS. 16-20, the damper assembly 100 is in a by-pass mode (e.g., by-pass gap present) when the lid is relatively close to a fully open position and/or moving in the opening direction, but otherwise in a damping mode. For example, the damper assembly 100 is in the damping mode when closing at 70 degrees, but in the by-pass mode when opening at 70 degrees. The actuator 106 and cooperating features of the rotor (e.g., cam surface 136, actuator rib 134) may be sized and positioned to provide the particular rotational positions (and directions) at which the damper assembly is in the damping mode or by-pass mode. The relative amount of damping provided when in the damping mode may be tailored by sizing and configured the groove 120.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

What is claimed is:

1. A damper assembly comprising:
a proximal end configured for mounting to an actuator;
a distal end opposite the proximal end, the distal end configured for the passage of damping fluid;
a housing extending at least partially between the proximal and distal ends, the housing comprising a cavity and a groove, the groove configured for passage of damping fluid, the groove disposed at a distal end of the cavity and the groove extending along a groove length and having at least one of a variable width or a variable depth; and
a rotor disposed within the housing and rotatably articulable with respect to the housing, the rotor comprising a displacement member that articulates with rotation of the rotor relative to the housing along the groove length to direct the damping fluid through the groove.

2. The damper assembly of claim 1, wherein the groove defines a C-shape along the groove length, and wherein the displacement member of the rotor defines a complimentary C-shape.

3. The damper assembly of claim 1, wherein the groove length extends from a first end to a second end, wherein the variable width reaches a maximum at an intermediate point between the first end and the second end.

4. The damper assembly of claim 3, wherein the variable width reaches the maximum at a midpoint of the length.

5. The damper assembly of claim 4, wherein the variable width is symmetric about the midpoint along the length.

6. The damper assembly of claim 1, wherein the rotor comprises an actuator rib disposed proximate the proximal end of the damper assembly, the actuator rib configured to be contacted by the actuator to urge the rotor to rotate in the housing.

7. The damper assembly of claim 1, wherein the rotor is axially movable within the housing, wherein the rotor defines a by-pass position at a first axial position and a damping position at a second axial position, wherein the rotor is urged toward the distal end of the damper assembly from the first axial position to the second axial position.

8. The damper assembly of claim 7, wherein the rotor has a sloped cam surface disposed proximate the proximal end of the damper assembly, wherein the rotor is displaced axially as the actuator rotates along the sloped cam surface.

9. The damper assembly of claim 1, wherein the rotor comprises a tuning rib disposed at the distal end of the displacement member, the tuning rib configured to cooperate with the groove to urge damping fluid through the groove.

10. The damper assembly of claim 1, wherein the housing comprises external ribs configured to prevent the housing from rotating with respect to the actuator and rotor.

11. A lid assembly comprising:
a lid having a hinge axis at which the lid pivots with respect to a container, the lid including an actuator disposed along the hinge axis; and
a damper assembly disposed along the hinge axis and operably coupled to the actuator, the damper assembly comprising:
a proximal end configured for mounting to the actuator of the lid;
a distal end opposite the proximal end, the distal end configured for the passage of damping fluid;
a housing comprising a cavity and a groove, the groove configured for passage of damping fluid, the groove disposed at a distal end of the cavity and the groove extending along a groove length and having at least one of a variable width or variable depth; and
a rotor disposed within the housing and rotatably articulable with respect to the housing, the rotor comprising a displacement member that articulates with rotation of the rotor relative to the housing along the groove length to direct the damping fluid through the groove.

12. The lid assembly of claim 11, wherein the groove defines a C-shape centered about the hinge axis extending along the groove length, and wherein the displacement member of the rotor defines a complimentary C-shape.

13. The lid assembly of claim 11, wherein the groove length extends from a first end to a second end, wherein the variable width reaches a maximum at an intermediate point between the first end and the second end.

14. The lid assembly of claim 13, wherein the variable width reaches the maximum at a midpoint of the length.

15. The lid assembly of claim 14, wherein the variable width is symmetric about the midpoint along the length.

16. The lid assembly of claim 11, wherein the rotor comprises an actuator rib disposed proximate the proximal end of the damper assembly, the actuator rib configured to be contacted by the actuator to urge the rotor to rotate in the housing.

17. The lid assembly of claim 11, wherein the rotor is axially movable along the hinge axis within the housing, wherein the rotor defines a by-pass position at a first axial position and a damping position at a second axial position, wherein the rotor is urged toward the distal end of the damper assembly from the first axial position to the second axial position.

18. The lid assembly of claim 17, wherein the rotor has a sloped cam surface disposed proximate the proximal end of the damper assembly, wherein the rotor is displaced axially as the actuator rotates along the sloped cam surface.

19. The lid assembly of claim 11, wherein the rotor comprises a tuning rib disposed at the distal end of the displacement member, the tuning rib configured to cooperate with the groove to urge damping fluid through the groove.

20. The lid assembly of claim 11, wherein the housing comprises external ribs configured to prevent the housing from rotating with respect to the actuator and rotor.
